(19) United States
(12) Patent Application Publication
(10) Pub. No.: US 2007/0127475 A1
(43) Pub. Date: Jun. 7, 2007

(54) Method and apparatus for switching nodes to a new packet data connection point

(76) Inventors: Ravi Kuchibhotla, Gurnee, IL (US); Dragan M. Boscovic, South Barrington, IL (US)

Correspondence Address: MOTOROLA, INC., 1303 EAST ALGONQUIN ROAD, IL01/3RD, SCHAUMBURG, IL, 60196, US

(21) Appl. No.: 11/294,250

(22) Filed: Dec. 5, 2005

(51) Int. Cl. H04L 12/56

(52) U.S. Cl. 370/390; 370/395.5

(57) ABSTRACT

Methods and apparatus for switching nodes from a current packet data connection point to a new packet data connection point are provided. According to one embodiment of the invention, at least one group of nodes that are in communication with a network infrastructure using a first packet data connection point are identified (304) based, at least in part, on at least one predefined criterion. This group of selected nodes is then reestablished (306) using a second packet data connection point.

### TECHNICAL FIELD

This invention relates generally to a technique for switching nodes from a current packet data connection point to a new packet data connection point.

### BACKGROUND

Current higher data rate services and high bandwidth requirements present multiple challenges in the area of signaling overhead. In particular, reassignment of mobiles to a different cell or reallocation of resources in the same cell presents critical issues in cases of higher priority traffic and/or loss of resource availability for other higher priority data in the same cell. In such cases, for example, users of these higher priority data can be moved to other frequencies, other cells, and/or an alternate network in order to accommodate their higher priority status.

In the case of 4^{th} Generation networks, mobility protocols that are based on Internet Protocol are expected to determine the corresponding mobility management. Internet Protocol networks bring new approaches to transmit data, such as Internet Protocol multicast. Moreover, Internet Protocol networks also imply mobility layer in addition to the radio micro-mobility that is already inherent to wireless systems.

As a result, the resources are accordingly divided based on different priorities of the transmitted data. For example, multiple users may often be assigned the same resource for multicast purposes. Alternatively, multiple users may be sharing the same resource for unicast data in a time-multiplexed fashion with other users. There is a constant search to find a more efficient way to allocate resources among these various users in order, for example, to reduce signaling overhead and latency.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 comprises a block diagram of a typical wireless communication system suitable for various embodiments of the invention;

FIG. 2 comprises a block diagram of a node device suitable for various embodiments of the invention;

FIG. 3 comprises a flow chart diagram of an allocation process implemented at a network element according to an embodiment of the invention;

FIG. 4 comprises a flow chart diagram of a reestablishment process shown in FIG. 3 according to an embodiment of the invention; and

FIG. 5 comprises a flow chart diagram of a process implemented at a mobile station according to an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, at least one group of nodes that are in communication with a network infrastructure using a first packet data connection point are identified based, at least in part, on at least one predefined criterion. The connection to this group of selected nodes is then reestablished using a second packet data connection point. For one specific embodiment, a group identifier that identifies the plurality of selected nodes belonging to the group is sent. According to an embodiment, to reestablish the connection to these selected nodes, an address of the second packet data connection point is sent to the selected nodes.

According to various embodiments, a new packet data connection point is received to change a current packet data connection point. In response, the current packet data connection point is accordingly switched to the new packet data connection point. In an embodiment, the group identifier is also received, which identifies membership in the group of selected nodes to be switched to the new packet data connection point. In other embodiments, a request to switch from the current packet data connection point is sent to trigger the sending of a network address of the new packet data connection point. In other embodiments, the trigger to switch to an alternate packet connection point may be transmitted by setting an information element in a control message, and following reception of the message all members of the group identified by the control message perform the switch to an alternate packet connection point. In other embodiments, the alternate packet data connection point identity may be provided through efficient signaling means by identifying/providing only the modified parts of the packet data connection point address.

According to various embodiments, an apparatus is also included along with a memory having information corresponding to the predefined criterion stored therein and a controller circuit operably coupled to the memory that identifies the group of selected nodes using the first packet data connection point based, at least in part, on the predefined criterion and reestablishes the at least one group of plurality of selected nodes using a second packet data connection point. In one embodiment, a transceiver operably coupled to the controller circuit is included to send the group identifier that identifies the plurality of selected nodes belonging to the at least one group and a network address of the second packet data connection point to the selected plurality of nodes.

In specific embodiments, the predefined criterion may be based upon a membership in an Internet Protocol subnet in a source network, connection to an Internet Protocol Gateway, membership in a multicast group, usage of a beam-forming antenna resource, usage of frequency resources of time-multiplex, usage of time and frequency resources, radio capability, geographical location, geographical proximity, at least one multimedia capability of a node, at least one radio connectivity capability of a node, service subscription, at least one quality of service preference, at least one security level requirement, information regarding at least one battery resource, at least one energy resource, at least one software upgrade, at least one software reconfiguration, and/or at least one management instruction of a node, to note but a few.

According to other embodiments, the identification of these selected nodes is triggered by, for example, an overload of a current packet data connection, transmission flow of a higher priority packet, data content request in substantially the same format as at least one node on the network infrastructure, a change in power level, a need for a node reconfiguration based, at least in part, on a diagnostic test, a need for a service reconfiguration based, at least in part, on a diagnostic test, and/or at least one driver update. In other embodiments, the network infrastructure may comprise one or more of a wireless network, a radio network, a cellular network, a local area network, a distributed network, a mesh network, a push-to-talk network, a dispatch network, a telephony network, a broadcast network, an information technology network, a highway information network, a satellite network, a power grid network, and a security network.

Through the various embodiments, an improved technique for switching nodes to a new packet data connection point has been provided that, among other things, triggers handover using packet data connections. As a result, priority of the transmitted data is more accurately considered when allocating resources on the network. Moreover, the various teachings extend the principle of group handover to the packet data layer for seamless integration with radio mobility. In particular, by reestablishing selected nodes to a different packet data connection points, a more efficient allocation of resources has been provided that reduces signaling overhead and latency.

As required, detailed embodiments of the present invention are disclosed herein. However, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but, rather, to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

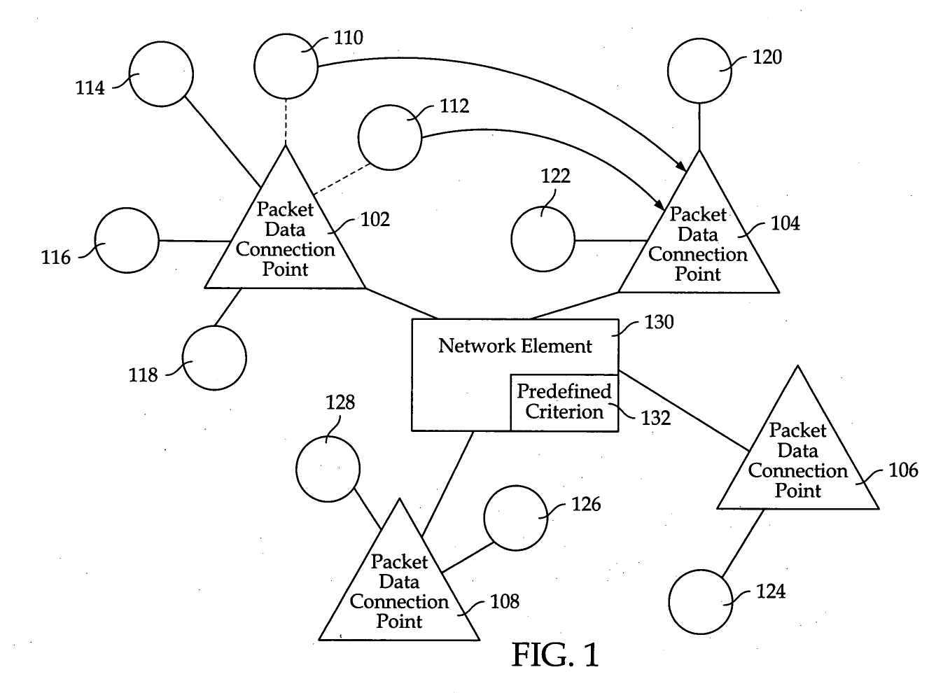

Referring now to the drawings, and in particular to FIG. 1, for purposes of providing an illustrative but non-exhaustive example to facilitate this description, a specific operational paradigm using a wireless communication system is shown and indicated generally at numeral reference 100. Those skilled in the art, however, will recognize and appreciate that the specifics of this illustrative example are not specific to the invention itself and that the teachings set forth herein are applicable in a variety of alternative settings. For example, since the teachings described are not platform dependent, they can be applied to various systems, such as, but not limited to, a wireless network, a radio network, a cellular network, a local area network, a distributed network, a mesh network, a push-to-talk network, a dispatch network, a telephony network, a broadcast network, an information technology network, a highway information network, a satellite network, a power grid network, and a security network. In fact, any communication network that transmits data packets is contemplated, and these various embodiments are within the scope of the invention. As such, the nodes, as described, refer to any devices that transmit or receive data packets, which include, but are not limited to, cell phones, personal digital assistants, and/or computer devices.

Referring now to the exemplary communication network shown in FIG. 1, four packet data connection points 102, 104, 106, and 108 that provide services to multiple nodes 110, 112, 114, 116, 118, 120, 122, 124, 126, and 128 are shown. These packet data connection points 102, 104, 106, and 108 along with the nodes 110, 112, 114, 116, 118, 120, 122, 124, 126, and 128 are operably coupled to a network element 130. Specifically, the network element 130 identifies, based on one or more predefined criteria 132, a group of selected nodes, for example nodes 110 and 112, to be reestablished using another packet data connection point 104. According to this embodiment shown, the predefined criterion 132 is stored in the network element in this embodiment. Since the predefined criterion 132 may be detected either by the nodes 110, 112, 114, 116, 118, 120, 122, 124, 126, and 128 or the network element 130, it is contemplated that the predefined criterion can be stored at any component (or components) in the network infrastructure.

According to various embodiments, multiple predefined criteria are contemplated, such as, but not limited to, membership in an Internet Protocol subnet in a source network, connection to an Internet Protocol Gateway, membership in a multicast group, usage of a beam-forming antenna resource, usage of frequency and/or time-multiplexed resources, usage of time and frequency resources, radio capability, geographical location, geographical proximity, at least one multimedia capability of a node, at least one radio connectivity capability of a node, service subscription, at least one quality of service preference, at least one security level requirement, at least one battery resource, at least one energy resource, at least one software upgrade, at least one software reconfiguration, and/or at least one management instruction of a node.

In this example shown, nodes 110 and 112 may have moved out of the optimal proximity of the packet connection point 102. In this case, depending upon the specific embodiment, either the nodes 110 and 112 or the network element 130 detects the availability of a more suitable packet data connection point 104. The network element 130 accordingly reestablishes nodes 110 and 112 to the packet data connection point 104. Specifically, in one embodiment, the network element sends a network address of the second packet data connection point 104 to nodes 110 and 112. Moreover, the various teachings contemplate that the network element 130 can either be integrated as part of or as a separate component connected to the connection points 102, 104, 106, and 108. Other embodiments that are readily apparent to a skilled artisan are also contemplated and are within the scope of the various teachings.

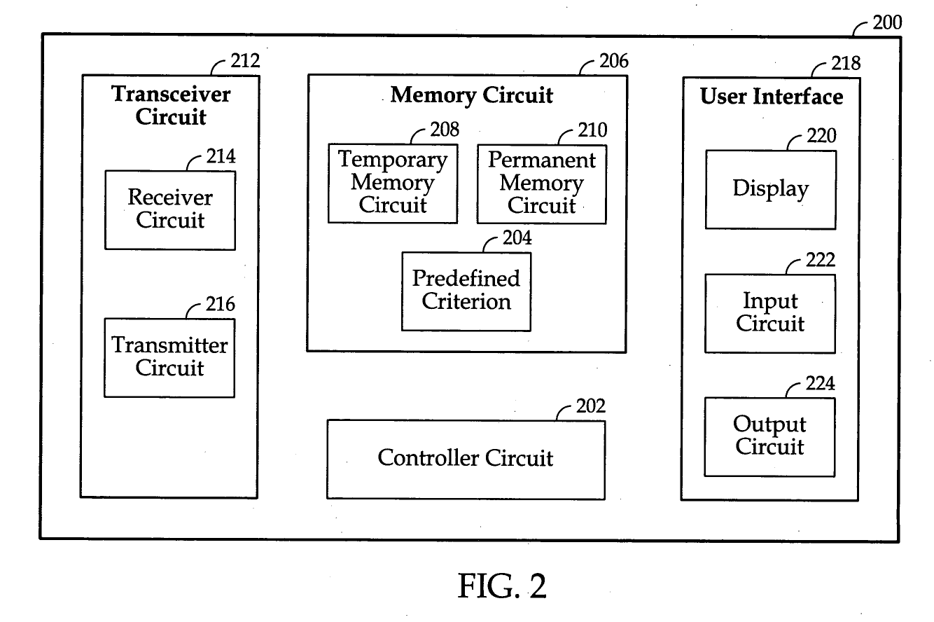

Referring to FIG. 2, a node device 200 suitable for various embodiments is shown. For simplicity and clarity, it should be noted that FIG. 2, for purposes of clarity, does not present all the hardware components needed in a typical node device, which are otherwise commonly included and known in the art. Moreover, as a skilled artisan readily appreciates, other hardware configurations and circuitry topology layouts, although not shown, can be used to implement the various teachings described. As such, the node device 200 shown in FIG. 2 is provided as a practical example to implement the teachings of the various embodiments. Moreover, “circuit” refers to one or more component devices such as, but not limited to, processors, memory devices, application specific integrated circuits (ASICs), and/or firmware, which are created to implement or adapted to implement (perhaps through the use of software) certain functionality, all within the scope of the various teachings described.

In this exemplary node device shown, a controller circuit 202 is included that identifies at least one group of nodes using a first packet data connection point based on a predefined criterion 204 that is stored, for this embodiment, in a memory circuit 206, which includes both a temporary memory circuit 208 and a permanent memory circuit 210. These groups of selected nodes, which are in communication with a network infrastructure, are then directed to reestablish their communication connection using a second packet data connection point. According to one embodiment, the controller circuit 202 specifically sends a group identifier to identify the plurality of selected nodes belonging to the at least one group and/or a network address of the second packet data connection point to the selected plurality of nodes via a transceiver circuit 212 that includes a receiver circuit 214 and a transmitter circuit 216, as typically provided in a node device.

In one embodiment, the controller circuit is triggered by any one or more selected from a group of an overload of a current packet data connection, transmission flow of a higher priority packet, data content request in a substantially same format as at least one node on the network infrastructure, a change in power level, a need for a node reconfiguration based, at least in part, on a diagnostic test, a need for a service reconfiguration based, at least in part, on a diagnostic test, and/or at least one driver update. A user interface 218 is also typically provided, which includes a display 220 for displaying data to the user, an input circuit 222, such as a recorder, for providing input data, and an output circuit 224, such as an antenna, for providing data transmission to the infrastructure, such as the base stations.

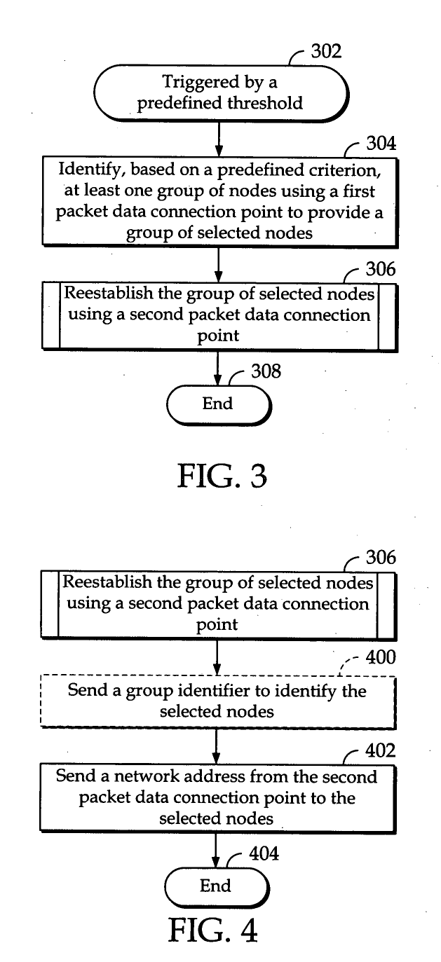

Turning now to FIG. 3, a flow chart diagram of an allocation process, according to an embodiment of the invention, implemented at a network element is shown and indicated generally at numeral reference 300. Although the process shown may often be implemented at a network element, there may be other implementations of each of the processes shown that are better for other components in the infrastructure in the communication system. These processes shown, thus, can be implemented fully or partially at any of the components within the system. Moreover, as one skilled in the art can readily appreciate, any of the processes shown can be altered in multiple ways to achieve the same functions and results of the various teachings described. As a result, these processes shown are one exemplary embodiment of multiple variation embodiments that may not be specifically shown. Thus, the processes shown are directed to the system, and each of them may be altered slightly to accommodate any of the components in the communications system. These other embodiments, however, are within the scope of the various teachings described.

In light of this, this particular allocation process 300 starts 302 by a trigger defined by at least one predefined threshold. In response, the process 300 identifies 304, based on a predefined criterion, one or more groups of nodes that are using the first packet data connection point to provide a group of selected nodes. These identified selected nodes are accordingly directed to reestablish 306 their communication connection using a second packet data connection point, which ends 308 the process at this point.

Referring now to FIG. 4, a flow chart diagram of a reestablishment process shown in FIG. 3 according to one embodiment of the invention is shown and indicated generally at numeral reference 306. This particular reestablishment process 306 shown starts with an optional group identifier 400, which is sent to the node device for identifying the selected nodes belonging to the group to be switched to the second packet data connection point. Moreover, in order for the node device to reestablish its connection using the second packet data connection point, a network address of the second packet data connection point is sent 402 to these selected nodes. The process 306 is completed 404 at this point.

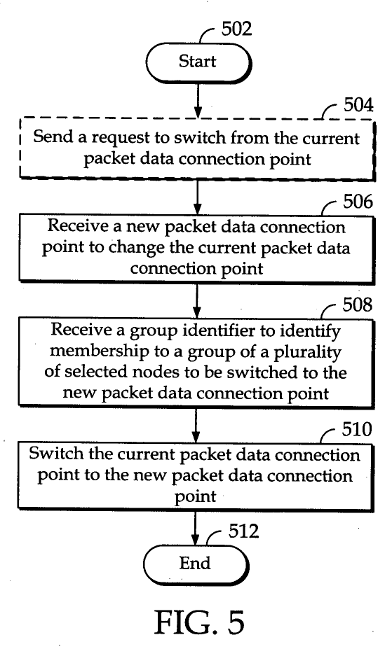

Turning now to FIG. 5, a flow chart diagram of a process implemented at a node device according to an embodiment of the invention is shown and indicated generally at numeral reference 500. The process 500 is initiated 502 with an optional step of sending 504 a request to switch from a current packet data connection. In particular, for example, this request can be triggered by a user request or by the predefined criterion that is stored in the node device itself. Depending upon the specific implementation and the scenario of the node device, this request may be sent to invoke the switch. Alternatively, this request can also be invoked from the network element. According to other various embodiments, the trigger to switch to an alternate packet connection point may be transmitted by setting an information element in a control message, and following reception of the message all members of the group identified by the control message perform the switch to an alternate packet connection point. In other embodiments, the alternate packet data connection point identity may be provided through efficient signaling means by identifying/providing only the modified parts of the packet data connection point address. In either case, the process 500 of the node device should then receive 506, 508 a new packet data connection point to change the current connection point and an optional group identifier that identifies its membership from a group of selected nodes for switching to this new packet data connection point. Accordingly, the process 500 of the node device switches 510 from the current packet data connection point to the new packet data connection point, which ends 512 the process 500 at this point.

Through these various embodiments, an improved technique for switching nodes to a new packet data connection point has been provided that, among other things, triggers handover using packet data connections. As a result, priority of the transmitted data is more accurately considered when allocating resources on the network. Moreover, the various teachings extend the principle of group handover to the packet data layer for seamless integration with radio mobility. In particular, by reestablishing selected nodes to different packet data connection points, a more efficient allocation of resources has been provided that reduces signaling overhead and latency.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
identifying at least one group of nodes using a first packet data connection point based, at least in part, on at least one predefined criterion to provide at least one group of a plurality of selected nodes in communication with a network infrastructure;
reestablishing the at least one group of plurality of selected nodes using a second packet data connection point.

2. The method according to claim 1, wherein the at least one predefined criterion comprises one or more selected from a group of membership to an Internet Protocol subnet in a source network, connection to an Internet Protocol Gateway, membership in a multicast group, usage of a beam-forming antenna resource, usage of frequency resources of time-multiplex, usage of time and frequency resources, radio capable, geographical location, geographical proximity, at least one multimedia capability of a node, at least one radio connectivity capability of a node, service subscription, at least one quality of service preferences, at least one security level requirement, at least one battery resource, at least one energy resource, at least one software upgrade, at least one software reconfiguration, and at least one management instruction of a node.

3. The method according to claim 1, wherein the network infrastructure comprises one or more selected from a group of a wireless network, a radio network, a cellular network, a local area network, a distributed network, a mesh network, a push-to-talk network, a dispatch network, a telephony network, a broadcast network, an information technology network, a highway information network, a satellite network, a power grid network, and a security network.

4. The method according to claim 1, wherein identifying the at least one group of nodes is triggered by any one or more selected from a group of an overload of a current packet data connection, transmission flow of a higher priority packet, data content request in substantially same format as at least one node on the network infrastructure, a change in power level, a need for a node reconfiguration based, at least in part, on a diagnostic test, a need for a service reconfiguration based, at least in part, on a diagnostic test, and at least one driver update.

5. The method according to claim 1 further comprising:
sending a group identifier to identify the plurality of selected nodes belonging to the at least one group.

6. The method according to claim 1, wherein reestablishing the at least one group of plurality of selected nodes using a second packet data connection point further comprises:
sending a network address of the second packet data connection point to the plurality of selected nodes.

7. A method comprising:
receiving a new packet data connection point to change a current packet data connection point triggered by, at least in part, at least one predefined criterion;
switching the current packet data connection point to the new packet data connection point.

8. The method according to claim 7 further comprising:
receiving an indication to perform a switch of the current packet data connection point to the new packet data connection point

9. The method according to claim 7 further comprising:
receiving a group identifier to identify membership to a group of a plurality of selected nodes to be switched to the new packet data connection point.

10. The method according to claim 7 further comprising:
receiving a network address of the new packet data connection point.

11. The method according to claim 10, wherein receiving a network address of the new packet data connection point further comprises:
receiving a modified portion of a network address of the current packet data connection point.

12. The method according to claim 7 further comprising, prior to receiving a new packet data connection point to change a current packet data connection point triggered by, at least in part, at least one predefined criterion:
sending a request to switch from the current packet data connection point.

13. The method according to claim 7, wherein the predefined criterion comprises one or more selected from a group of membership to an Internet Protocol subnet in a source network, connection to an Internet Protocol Gateway, membership in a multicast group, usage of a beam-forming antenna resource, usage of frequency resources of time-multiplex, usage of time and frequency resource, radio capable, geographical location, geographical proximity, at least one multimedia capability of a node, at least one radio connectivity capability of a node, service subscription, at least one quality of service preferences, at least one security level requirement, at least one battery resource, at least one energy resource, at least one software upgrade, at least one software reconfiguration, and at least one management instruction of a node.

14. The method according to claim 7, wherein the network infrastructure comprises one or more selected from a group of a wireless network, a radio network, a cellular network, a local area network, a distributed network, a mesh network, a push-to-talk network, a dispatch network, a telephony network, a broadcast network, an information technology network, a highway information network, a satellite network, a power grid network, and a security network.

15. An apparatus comprising:
a memory circuit having information corresponding to a predefined criterion stored therein;
a controller circuit operably coupled to the memory and that identifies at least one group of nodes using a first packet data connection point based, at least in part, on the predefined criterion to provide at least one group of a plurality of selected nodes in communications with a network infrastructure and that reestablishes the at least one group of plurality of selected nodes using a second packet data connection point.

16. The apparatus according to claim 15, wherein the predefined criterion comprises one or more selected from a group of membership to an Internet Protocol subnet in a source network, connection to an Internet Protocol Gateway, membership in a multicast group, usage of a beam-forming antenna resource, usage of frequency resources of time-multiplex, usage of time and frequency resources, radio capable, geographical location, geographical proximity, at least one multimedia capability of a node, at least one radio connectivity capability of a node, service subscription, at least one quality of service preferences, at least one security level requirement, at least one battery resource, at least one energy resource, at least one software upgrade, at least one software reconfiguration, and at least one management instruction of a node.

17. The apparatus according to claim 15, wherein the network infrastructure comprises one or more selected from a group of a wireless network, a radio network, a cellular network, a local area network, a distributed network, a mesh network, a push-to-talk network, a dispatch network, a telephony network, a broadcast network, an information technology network, a highway information network, a satellite network, a power grid network, and a security network.

18. The apparatus according to claim 15, wherein the controller circuit is triggered by any one or more selected from a group of an overload of a current packet data connection, transmission flow of a higher priority packet, data content request in substantially same format as at least one node on the network infrastructure, a change in power level, a need for a node reconfiguration based, at least in part, on a diagnostic test, a need for a service reconfiguration based, at least in part, on a diagnostic test, and at least one driver update.

19. The apparatus according to claim 15 further comprising:
a transceiver operably coupled to the controller circuit and that sends a group identifier to identify the plurality of selected nodes belonging to the at least one group.

20. The apparatus according to claim 15 further comprising:
a transceiver operably coupled to the controller circuit and that sends a network address of the second packet data connection point to the selected plurality of nodes.
